(19) United States
(12) Patent Application Publication
(10) Pub. No.: US 2006/0033062 A1
(43) Pub. Date: Feb. 16, 2006

(54) Valve for controlling fluids

(76) Inventors: Siegfried Ruthardt, Altdorf (DE); Bernd Streicher, Filderstadt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/537,370

(22) PCT Filed: Mar. 19, 2004
(86) PCT No.: PCT/DE04/00566

§ 371 Date: Jun. 3, 2005

(30) Foreign Application Priority Data
May 20, 2003 (DE) 103 22 672.9

(51) Int. Cl. F16K 31/02

(52) U.S. Cl. 251/129.06; 239/102.2

(57) ABSTRACT

A fluid control valve having a holder body that has a receptacle containing a piezoelectric actuator unit and a hydraulic coupler module that has at least one positioning piston and at least one actuating piston that is operatively connected to the positioning piston via a hydraulic coupler and actuates a valve-closure member that cooperates with at least one valve seat and in the closed position, prevents a flow of fluid from a valve chamber to a return conduit. The positioning piston is guided in the receptacle by means of a seal.

### PRIOR ART

The invention is based on a valve for controlling fluids according to the type defined in greater detail in the preamble to claim 1.

A valve this kind is known from the prior art and is used, for example, as a control module of a fuel injection valve, in particular of a common rail injector for a diesel internal combustion engine of a motor vehicle.

The valve, which is embodied in the form of a control module, has a housing that serves as a holder body and contains a receptacle for a piezoelectric actuator unit and a hydraulic coupler module. The hydraulic coupler module has a control piston, which can be actuated by the actuator unit, and an actuating piston, which is operatively connected to the positioning piston via a hydraulic coupler and acts on a valve-closure member that cooperates with at least one valve seat. In the closed position, the valve-closure member shuts off a flow of fluid from a valve chamber to a return flow conduit. When the valve-closure member is open, a pressure relief occurs in the valve chamber and therefore in a valve control chamber, which is connected to the valve chamber and is used to actuate a valve control piston or a nozzle needle.

The valve control chamber and the valve control piston are associated with a nozzle module of the injection valve, the tip of which is provided with nozzles for injecting fuel into a combustion chamber of an engine. The valve control chamber encompasses the free end of the valve control piston and is connected via a fuel supply line to a high-pressure connection that fills it with fuel. The position of the valve control piston can be changed as a function of the level of pressure that the control module sets in the valve control chamber, thus making it possible to control the fuel injection that occurs via the injection valve openings leading to the combustion chamber of the engine. Thus the control module determines the position of the valve control piston and therefore that of the nozzle needle. The valve chamber of the control module and the valve control chamber of the nozzle module communicate with each other via an outlet throttle.

In the known valve, the coupler module and the piezoelectric actuator unit are bathed in fuel during operation. In the hydraulic coupler module, this is necessary because the hydraulic coupler, which is embodied in the form of a hydraulic cushion, is disposed between the positioning piston and the actuating piston and, during an actuation, loses hydraulic fluid or fuel due to leakage and must be refilled, which occurs by means of the fuel surrounding the coupler module.

The piezoelectric actuator unit includes a piezoelectric actuator that must not come into contact with fuel. For these reasons, the actuator unit in the prior art had to be provided with a complex housing that also had to be leak tested before being mounted in the holder body.

### ADVANTAGES OF THE INVENTION

The valve for controlling fluids according to the present invention, with the characteristics recited in the preamble to claim 1, in which valve, the positioning piston is guided in the receptacle by means of a seal, has the advantage that the hydraulic coupler module can in fact be bathed in the fluid, thus assuring a refilling of the hydraulic coupler, but the region of the receptacle in which the piezoelectric actuator unit is disposed is sealed so that it cannot come into contact with the fluid. It is therefore no longer necessary to encapsulate the actuator unit. The actuator unit can therefore be embodied without a metal sleeve and without a corrugated bellows or diaphragm. This also eliminates the need for the previously required complex laser welding procedures. In addition, the actuator unit no longer has to be tested for helium tightness before being installed.

It is also no longer necessary to provide an O-ring to seal electrical feeds off from the receptacle region containing the actuator unit. Since the receptacle region containing the actuator unit is free of fluid, it is also unnecessary to provide a return bore in the holder body, leading from this region to a return conduit for conveying the fluid back to a storage tank.

The valve according to the invention can in particular be used in an injection valve that is a component of a common rail injection system of a diesel internal combustion engine of a motor vehicle.

In order to fix the seal in place on the positioning piston, it can be provided with an annular groove in which the seal is seated.

Alternatively, the seal can be fixed in place on the positioning piston so that it is disposed between an annular collar of the positioning piston and a positioning washer of the positioning piston and is thus fixed in the axial direction of the positioning piston.

Essentially, the seal can come in the form of any annular seal capable of absorbing the stroke of the positioning piston. The stroke of the positioning piston is a maximum of 50 mm, for example, in an injection valve. For example, the seal is embodied in the form of an O-ring seal or a diaphragm or bellows seal.

In order to be able to insert the positioning piston with the seal mounted on it easily into the receptacle, the receptacle is preferably embodied as stepped in the region of the coupler module, with a first diameter and a second diameter that is smaller than the first diameter, the seal being disposed in the region of the second diameter. Then during assembly, the seal need only slide a short distance along the wall of the receptacle, which minimizes the risk of leaks.

To further simplify assembly, the receptacle is advantageously provided with an insertion bevel, which forms a transition between the region with the first diameter and the region with the second diameter; during assembly, the seal slides along this insertion bevel toward its installation position.

Other advantages and advantageous embodiments of the subject of the present invention can be inferred from the specification, the drawings and the claims.

### DRAWINGS

Two exemplary embodiments of the valve according to the present invention are depicted in a schematically simplified form in the drawings and will be explained in greater detail in the subsequent description.

FIG. 1 shows an injection valve with a valve according to the present invention;

FIG. 2 shows an enlarged view of the region II in FIG. 1;

FIG. 3 shows a holder body of the injection valve according to FIG. 1; and

FIG. 4 shows an alternative embodiment form of a valve according to the present invention in a depiction that corresponds to FIG. 2.

### DESCRIPTION OF THE EXEMPLARY EMBODIMENTS

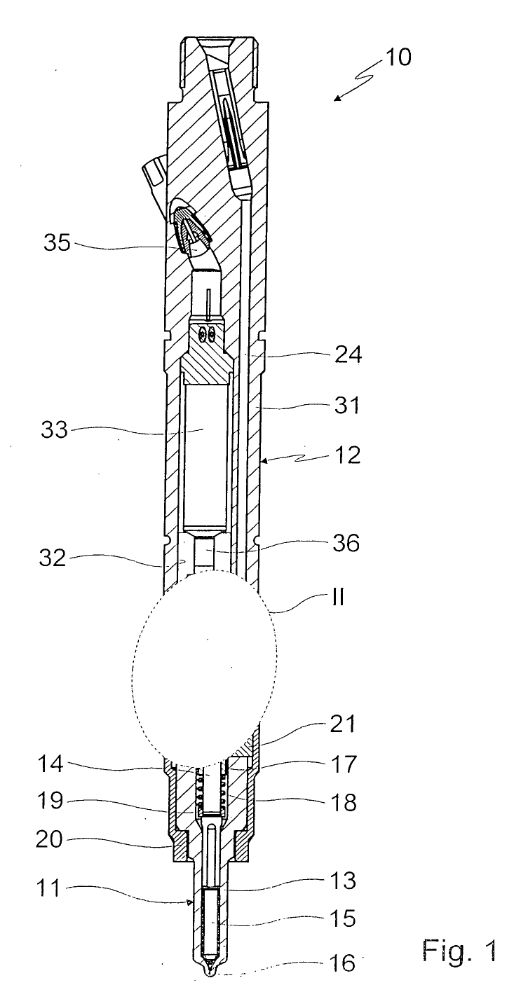

FIGS. 1 to 3 show a fuel injection valve 10 designed to be installed in an internal combustion engine, not shown in detail here, of a motor vehicle, and for use as a common rail injector preferably for injecting diesel fuel into a combustion chamber of an engine. To this end, the essential components of the fuel injection valve 10 are a nozzle module 11 and a valve control module 12.

The nozzle module 11 has a nozzle body 13 in which a so-called valve control piston 14 is guided in an axially movable fashion, which piston, together with a nozzle needle 15, comprises a component that can control an opening or nozzle 16 of the injection valve 10 leading to the combustion chamber of the engine.

The free end of the valve control piston 14 is guided in a sleeve 17 against which one end of a helical spring 18 encompassing the valve control piston 14 rests, the other end of which rests against a support 19 connected to the valve control piston 14.

The nozzle module 11 is connected to the valve control module 12 by means of a clamping nut 20; a throttle plate 21 is disposed between the nozzle module 11 and the valve control module 12. The throttle plate 21, together with the sleeve 17 and the valve control piston 14, delimits a valve control chamber 22. The pressure ratios in the valve control chamber 22 determine the position of the valve control piston 14 and the nozzle needle 15.

A supply conduit 23 that contains a supply throttle connects the valve control chamber 22 to a supply line 24 for fuel and to a high-pressure accumulator, not shown in detail here, the so-called common rail. The fuel supply line 24 also supplies fuel to the tip of the nozzle needle 15 so that when the nozzle needle 15 unblocks the opening 16, the fuel is injected into the combustion chamber of the engine.

An outlet conduit, which is not shown in the drawing and contains an outlet throttle, also connects the valve control chamber 22 to a valve chamber 25 to which a bypass 26 connected to the fuel supply line 24 also leads, which valve chamber is associated with the valve control module 12. The supply conduit 23, the outlet conduit leading to the valve chamber 25, and the bypass 26 pass through the throttle plate 21.

The valve chamber 25 contains a valve-closure member 27 that is prestressed in the direction away from the throttle plate 21 by means of a helical spring 28 and cooperates with a first valve seat 29 embodied as a flat seat and a second valve seat 30 embodied as a conical seat.

The valve control module 12 also includes a holder body 31 that contains the fuel supply line 24, a receptacle 32 for a piezoelectric actuator unit 33, and a coupler module 34. The piezoelectric actuator unit 33 is connected to electrical control lines 35 and is operatively connected to the hydraulic coupler module 34 via an actuator head 36.

The hydraulic coupler module 34 has a first piston 37 embodied in the form of a positioning piston, which is operatively connected to a second piston 39 referred to as an actuating piston via a coupler 38 embodied in the form of a hydraulic cushion; the actuating piston 39 has a smaller diameter than the positioning piston 37. The positioning piston 37 and the actuating piston 39 are guided in a cylindrical sleeve 40 that stands upright on an intermediate plate 41 and contains radial bores 42 that connect a return chamber 43 disposed downstream of the valve seat 30 to the outside of the cylindrical sleeve 40. In the closed position, the valve-closure member 27 prevents fluid from flowing between the valve chamber 25 and the return chamber 43.

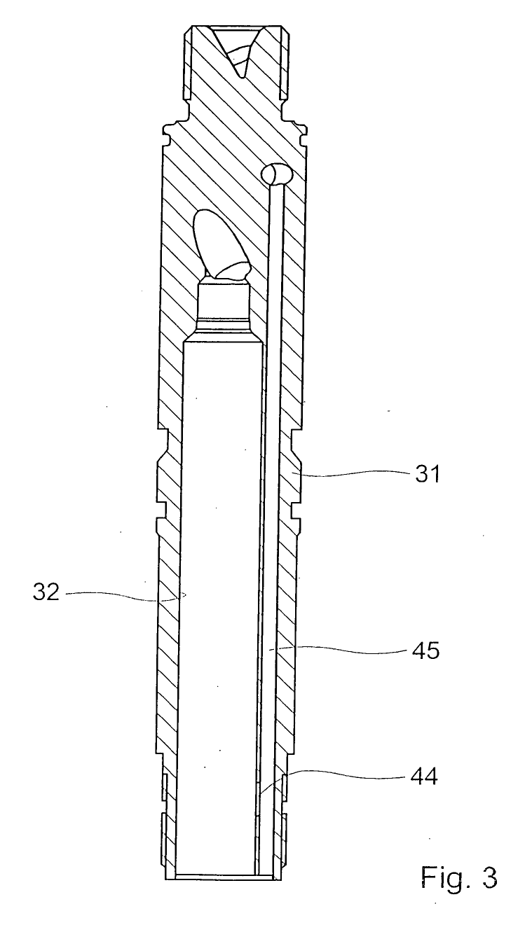

As is apparent from FIG. 3, the region of the receptacle 32 containing the coupler module 34 has a return opening 44 branching off from it, which is contained in the holder body 31 and leads to an axially oriented return line 45 also contained in the holder body 31, which in turn leads to a fuel tank not shown in detail here. The return chamber 43 is thus connected to the return line 45 via the radial bore 42 and openings, not shown here, in a rigid, tubular spring 47.

The positioning piston 37, which the actuator head 36 engages via a support plate 51, is provided with an enlarged diameter in the region adjacent to the support plate 51. In this region, the positioning piston 37 has an annular groove 49 that contains an O-ring 50 serving as a seal, which rests against the wall of the receptacle 32. The region of the receptacle 32 containing the actuator unit 33 is therefore sealed in relation to the region of the receptacle 32 containing the coupler module 34. During operation of the inlet valve, the positioning piston 37 executes a maximum stroke of approximately 50 mm. This stroke can be compensated for by the elasticity of the material of which the O-ring 50 is made.

In addition, the positioning piston 37 is provided with a positioning washer 46 that rests against the tubular spring 47 disposed concentric to the sleeve 40 and can adjust the volume of the hydraulic coupler 38 disposed between the two pistons 37 and 39.

In the region containing the tubular spring 47, the receptacle 32 has a larger diameter than in the region containing the O-ring 50. Between the regions of different diameters, an insertion bevel 48 is provided, which facilitates the assembly of the coupler module 34. The O-ring 50 glides along this bevel into its installation position. In the assembled state, the adjusting washer 46 is disposed in the vicinity of the insertion bevel 48.

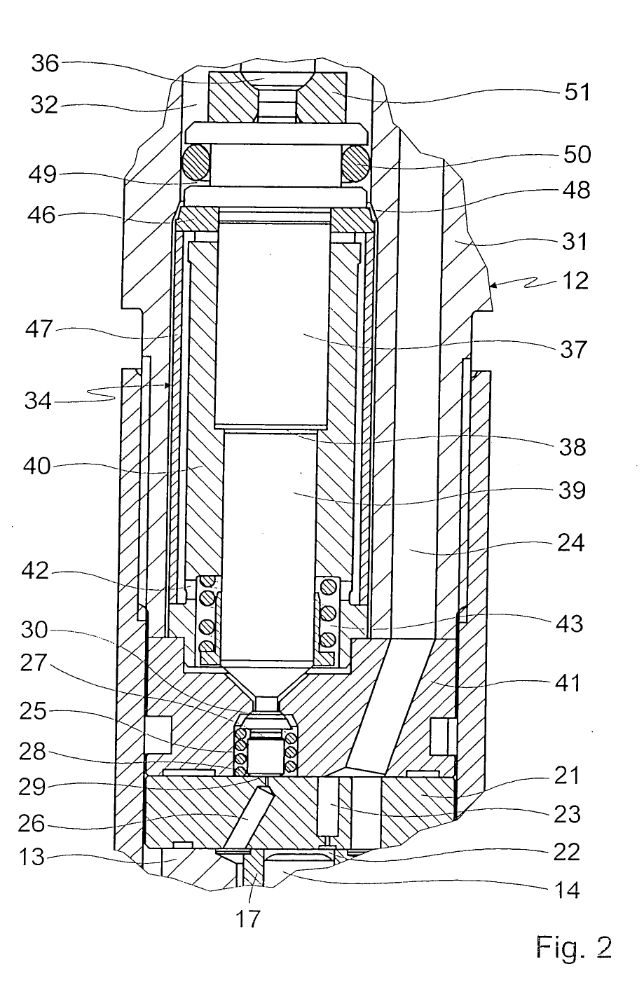

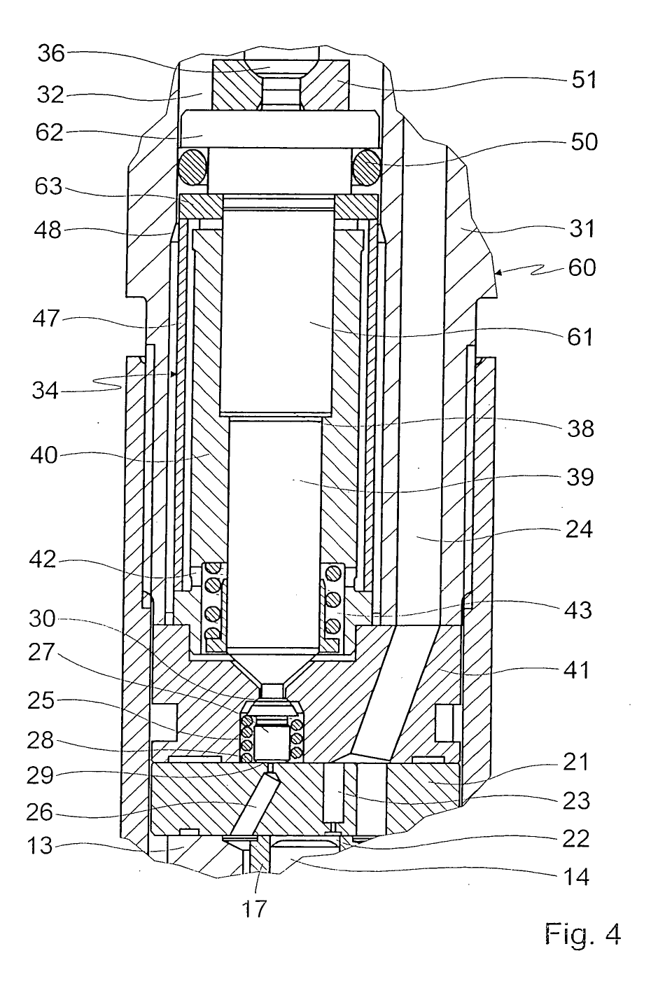

FIG. 4 shows an alternative embodiment form of a valve control module 60 of an injection valve of the type shown in FIG. 1. The valve control module 60 essentially corresponds to the valve control module shown in FIG. 2, but is distinguished from it by means of a control piston 61 whose end oriented toward the actuator head 36 is provided with an annular collar 62 that serves to fix an O-ring 50, which seals the region of the receptacle 32 containing the actuator unit in relation to the region of the receptacle 32 containing the coupler module 34.

The O-ring 50 is also fixed by means of a positioning washer 63 that serves to adjust the volume of the hydraulic coupler 38 and rests against the tubular spring 47. The adjusting washer 63 and the O-ring 50 are disposed in the smaller diameter region of the receptacle 32.

Otherwise, the design of the valve control module 60 corresponds to that of the valve control module according to FIG. 2.

1-7. (canceled)

8. In a valve for controlling fluids, having a holder body (31) including a receptacle (32) containing a piezoelectric actuator unit (33) and a hydraulic coupler module (34) that has at least one positioning piston (37, 61) and at least one actuating piston (39) that is operatively connected to the positioning piston (37, 61) via a hydraulic coupler (38) and actuates a valve-closure member (27) that cooperates with at least one valve seat (29, 30) and in the closed position, prevents a flow of fluid from a valve chamber (25) to a return conduit (45), the improvement comprising a seal (50) guiding the positioning piston (37, 61) in the receptacle (32).

9. The valve according to claim 8, wherein the positioning piston (37) comprises an annular groove (49), and wherein the seal (50) is fixed in the annular groove (49).

10. The valve according to claim 8, wherein the positioning piston (61) comprises an annular collar (62) and a positioning washer (63), and wherein the seal (50) is disposed between the annular collar (62) and the positioning washer (63).

11. The valve according to claim 8, wherein the seal (50) is embodied in the form of an O-ring.

12. The valve according to claim 9, wherein the seal (50) is embodied in the form of an O-ring.

13. The valve according to claim 10, wherein the seal (50) is embodied in the form of an O-ring.

14. The valve according to claim 8, wherein the seal is embodied in the form of a diaphragm or bellows seal.

15. The valve according to claim 9, wherein the seal is embodied in the form of a diaphragm or bellows seal.

16. The valve according to claim 10, wherein the seal is embodied in the form of a diaphragm or bellows seal.

17. The valve according to claim 8, characterized in that the receptacle (32) is embodied with a first diameter in the region of the coupler module (34) and with a second diameter that is smaller than the first diameter, and wherein the seal (50) is disposed in the region of the second diameter.

18. The valve according to claim 9, characterized in that the receptacle (32) is embodied with a first diameter in the region of the coupler module (34) and with a second diameter that is smaller than the first diameter, and wherein the seal (50) is disposed in the region of the second diameter.

19. The valve according to claim 10, characterized in that the receptacle (32) is embodied with a first diameter in the region of the coupler module (34) and with a second diameter that is smaller than the first diameter, and wherein the seal (50) is disposed in the region of the second diameter.

20. The valve according to claim 11, characterized in that the receptacle (32) is embodied with a first diameter in the region of the coupler module (34) and with a second diameter that is smaller than the first diameter, and wherein the seal (50) is disposed in the region of the second diameter.

21. The valve according to claim 14, characterized in that the receptacle (32) is embodied with a first diameter in the region of the coupler module (34) and with a second diameter that is smaller than the first diameter, and wherein the seal (50) is disposed in the region of the second diameter.

22. The valve according to claim 17, wherein an insertion bevel (48) connects the two receptacle regions with different diameters.

23. The valve according to claim 18, wherein an insertion bevel (48) connects the two receptacle regions with different diameters.

24. The valve according to claim 19, wherein an insertion bevel (48) connects the two receptacle regions with different diameters.

25. The valve according to claim 20, wherein an insertion bevel (48) connects the two receptacle regions with different diameters.

26. The valve according to claim 21, wherein an insertion bevel (48) connects the two receptacle regions with different diameters.
